(19) United States
(12) Patent Application Publication
(10) Pub. No.: US 2026/0024391 A1
(43) Pub. Date: Jan. 22, 2026

(54) INTEGRATED DOORLOCK RECHARGEABLE ENERGY STORAGE DEVICE AND METHOD FOR RECHARGING THEREOF

(71) Applicant: Vivint LLC, Provo, UT (US)

(72) Inventors: Cecilee Petersen, Provo, UT (US); Stephen Boynton, Provo, UT (US); Austin Matsuura, Provo, UT (US); Rikki Price, Provo, UT (US); Kris Nosack, Provo, UT (US)

(73) Assignee: Vivint LLC, Provo, UT (US)

(21) Appl. No.: 19/272,465

(22) Filed: Jul. 17, 2025

Related U.S. Application Data
(60) Provisional application No. 63/672,914, filed on Jul. 18, 2024.

(51) Int. Cl. G07C 9/00

(52) U.S. Cl. CPC G07C 9/00817; G07C 9/00182; G07C 2009/00222

(57) ABSTRACT

A door lock may include an exterior door lock plate assembly configured to be secured to a door. The door lock may include electronics configured to execute at least one function to support the door lock. A rechargeable energy storage element may be in electrical communication with the electronics, and be configured to store and supply electrical power to the electronics. An electrical conductor interface element may be in electrical communication with the rechargeable energy storage element. An electrical conductor may be electrically connected between the rechargeable energy storage element and the electronics. A strike plate and/or electrical connector thereat may provide electrical power to the electrical conductor interface element of the door lock using electrical conduction or induction such that power from the strike plate and/or electrical connector is supplied the rechargeable energy storage element when the door is in a closed state.

### CROSS REFERENCE TO RELATED APPLICATION

This application is a claims priority to U.S. Patent Application Ser. No. 63/672,914, filed Jul. 18, 2025, the entire contents of which are hereby incorporated by reference as though fully set forth herein.

### TECHNICAL FIELD

The current disclosure generally relates to smart door lock systems. More specifically, the current disclosure relates to integrated door locks with hands-free bump knobs.

### BACKGROUND

Smart doorknobs that necessitate users to turn or rotate the knob, as opposed to a straightforward pressing motion, may present certain drawbacks. The physical act of turning a knob can be cumbersome, especially for individuals with limited mobility or physical disabilities. This design may pose challenges for those who find it difficult to grasp and turn the knob, potentially limiting their ability to access their homes or buildings easily and independently. The rotational requirement of some smart doorknobs might be less convenient in certain situations, particularly when a user has their hands occupied with other items. For instance, individuals carrying groceries, bags, or holding a child may find it more challenging to manipulate a rotating knob.

Smart doorknobs also have a limited number of functions as defined by the manufacturer. These functions, once established, are generally limited by available hardware of the smart doorknob. If a user desires additional functionality, a new smart doorknob has to be purchased and installed to replace the existing smart doorknob.

### SUMMARY

Unlike traditional doorknobs that typically utilize rotation or turning, the hands-free bump knob allows the user to actuate the lock bolt by simply pushing the bump knob towards the door. This streamlined operation may be helpful in various scenarios where hands-free access or ease of use is paramount. For instance, when carrying items or in situations where manual dexterity may be limited, the hands-free bump knob provides a more accessible and intuitive means of opening doors. The design of the bump knob caters to a range of users, enhancing overall accessibility and user experience, particularly in residential and commercial settings where simplicity and convenience are key considerations. In scenarios where ease of use and convenience are paramount, a design that allows for direct and effortless access, such as a push mechanism, may offer a practical solution to the struggles listed above. The simplicity of a push-button mechanism, as opposed to rotational movements, is generally more user-friendly and inclusive, catering to a diverse range of individuals with varying physical abilities.

To enable a smartlock to have expanded functionality, a baseline smartlock may include the ability to add modules by way of electrical connectors and hardware adapters to add hardware and/or software functionality without having to purchase and install a new smartlock.

According to a first aspect, an integrated door lock includes a door lock plate assembly configured to be mounted to an exterior side of a door at a lock region. The integrated door lock may further include a hands-free bump knob supported by the door lock plate assembly and communicatively mechanically coupled to a bolt of the integrated door lock, which may be configured to (i) retract the bolt of the integrated door lock into a retracted state when the hands-free bump knob is pressed into an open state and (ii) extend the bolt of the integrated door lock into a non-retracted state when the hands-free bump knob is released from the open state into a closed state. The integrated door lock may further include wherein the door lock plate assembly is further configured to enable at least one physical module to be mechanically and communicatively attached thereto, the at least one physical module being communicatively coupled to an alarm system that monitors a premises and the at least one physical module being configured to transition the alarm system from an activated state to an inactivated state, and vice versa, when activated.

According to a second aspect, a method of operating an integrated door lock includes receiving, by an authentication module of a door lock interface coupled to an exterior side of a door, authentication data from a user. The method may further include comparing, by the authentication module, the authentication data to a list of stored authentication data. The method may further include enabling a hands-free bump knob to transition a bolt to a retracted state if the authentication data matches the stored authentication data. The method may further include in response to the hands-free bump knob being pressed towards the door lock plate, retract the bolt.

According to a third aspect, an integrated door lock includes a door lock plate assembly configured to be mounted to an exterior side of a door at a lock region. The integrated door lock may further include a hands-free bump knob supported by the door lock plate assembly and communicatively mechanically coupled to a bolt of the integrated door lock, and configured to (i) retract the bolt of the integrated door lock into a retracted state when the hands-free bump knob is pressed into an open state and (ii) extend the bolt of the integrated door lock into a non-retracted state when the hands-free bump knob is released from the open state into a closed state. The integrated door lock may further include an authentication module supported by the door lock plate assembly and communicatively coupled and configured to (i) enable a user to be authenticated, and (ii) prevent the hands-free bump knob from transitioning the bolt from the non-retracted state to the retracted state until the user is authenticated.

According to a fourth aspect, a door lock includes an exterior door lock plate configured to be secured to a door. The door lock may further include electronics configured to execute at least one function to support the door lock. The door lock may further include a rechargeable energy storage element in electrical communication with the electronics, and configured to store and supply electrical power to the electronics. The door lock may further include an electrical conductor interface element in electrical communication with the rechargeable energy storage element. The door lock may further include an electrical conductor electrically connected between the rechargeable energy storage element and the electronics.

According to a fifth aspect, a method of using a door lock includes electrically connecting, by an electrical conductor interface element, a rechargeable energy storage element with an energy source. The method may further include supplying electrical power, by the rechargeable energy storage element to electronics. The method may further include supporting, by the electronics, at least one function of the door lock.

### BRIEF DESCRIPTION OF THE DRAWINGS

A more complete understanding of the method and apparatus of the present invention may be obtained by reference to the following Detailed Description when taken in conjunction with the accompanying figures wherein:

FIG. 1 is a perspective view illustrating one embodiment of a security system inclusive of smart locks, according to an embodiment;

FIG. 2 is a perspective view illustrating one embodiment of a system for securing an enclosed space inclusive of smart locks, according to an embodiment;

FIG. 3A is a front side perspective view illustrating one embodiment of an interior integrated door lock installed or affixed to an interior surface of a door, according to an embodiment;

FIG. 3B is a front plan view illustrating another embodiment of an interior integrated door lock, according to an embodiment;

FIG. 3C is a front plan view illustrating another embodiment of an interior integrated door lock, according to an embodiment;

FIG. 4 is a front plan view illustrating one embodiment of an exterior door lock interface, according to an embodiment;

FIG. 5 is a block diagram illustrating one embodiment of a door lock control system, according to an embodiment;

FIG. 6 is a block flow diagram illustrating one embodiment of a method of operating an integrated door lock, according to an embodiment;

FIG. 7A is a side plan view illustrating one embodiment of an illustrative door lock interface with a hands-free bump knob in a closed state;

FIG. 7B is a side plan view illustrating one embodiment of the door lock interface with the hands-free bump knob of FIG. 7A in an open state;

FIG. 8A is a front side perspective view illustrating one embodiment of an interior door lock interface installed or affixed to an interior surface of a door and a corresponding door frame, according to an embodiment; and

FIG. 8B is a front side perspective view illustrating one embodiment of an interior door frame, according to an embodiment.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

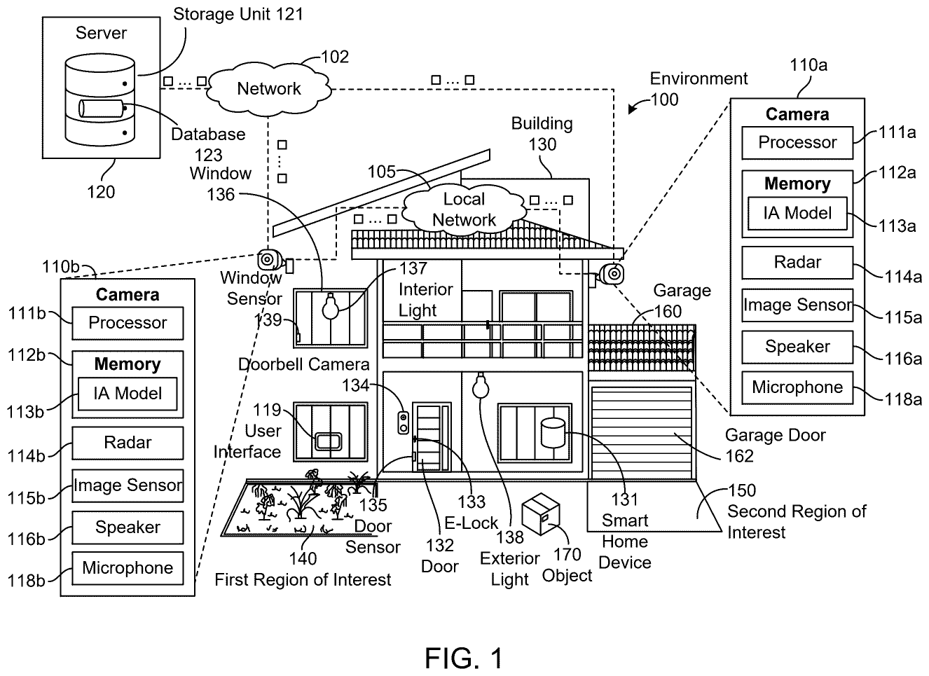

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

The building 130 may include a security system 101 or one or more security devices that are configured to detect and mitigate crime and property theft and damage by alerting a trespasser or intruder that their presence is known while optionally alerting a monitoring service about detecting a trespasser or intruder (e.g., burglar). The security system 101 may include a variety of hardware components and software modules or programs configured to monitor and protect the environment 100 and one or more buildings 130 located thereat. In an embodiment, the security system 101 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the building 130 in which the security system 101 is installed. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

The sensor(s) of the security system 101 may be used to detect a presence of a trespasser or intruder of the environment (e.g., outside, inside, above, or below the environment) such that the sensor(s) may automatically send a communication to the controller(s). The communication may occur whether or not the security system 101 is armed, but if armed, the controller(s) may initiate a different action than if not armed. For example, if the security system 101 is not armed when an entity is detected, then the controller(s) may simply record that a detection of an entity occurred without sending a communication to a monitoring service or taking local action (e.g., outputting an alert or other alarm audio signal) and optionally notify a user via a mobile app or other communication method of the detection of the entity. If the security system 101 is armed when a detection of an entity is made, then the controller(s) may initiate a disarm countdown timer (e.g., 60 seconds) to enable a user to disarm the security system 101 via a controller, mobile app, or otherwise, and, in response to the security system 101 not being disarmed (or being accepted by a user prior to completion of the countdown timer), communicate a notification including detection information (e.g., image, sensor type, sensor location, etc.) to a monitoring service (optionally after giving a user a chance to disarm the security system 101), which may, in turn, notify public authorities, such as police, to dispatch a unit to the environment 100, initiate an alarm (e.g., output an audible signal) local to the environment 100, communicate a message to a user via a mobile app or other communication (e.g., text message), or otherwise.

In the event that the security system 101 is armed and detects a trespasser or intruder, then the security system 101 may be configured to generate and communicate a message to a monitoring service of the security system 101. The monitoring service may be a third-party monitoring service (i.e., a service that is not the provider of the security system 101). The message may include a number of parameters, such as location of the environment 100, type of sensor, location of the sensor, image(s) if received, and any other information received with the message. It should be understood that the message may utilize any communications protocol for communicating information from the security service to the monitoring service. The message and data contained therein may be used to populate a template on a user interface of the monitoring service such that an operator at the monitoring service may view the data to assess a situation. In an embodiment, a user of the security system 101 may be able to provide additional information that may also be populated on the user interface for an operator in determining whether to contact the authorities to initiate a dispatch. The monitoring service may utilize a standard procedure in response to receiving the message in communicating with a user of the security service and/or dispatching the authorities.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the Internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be the same or similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect a breach of security event for which the respective sensors are configured. For example, the microphones 118 may be configured to sense sounds, such as voices, broken glass, door knocking, or otherwise, and an audio processing system may be configured to process the audio so as to determine whether the captured audio signals are indicative of a trespasser or potential intruder of the environment 100 or building 130. Each of the signals generated or captured by the different sensors may be processed so as to determine whether the sounds are indicative of a security risk or not, and the determination may be time and/or situation dependent. For example, responses to sounds made when the security system 101 is armed may be different to responses to sounds when the security system 101 is unarmed.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the security system 101 and/or security device may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person.

In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the security system 101 and/or security devices may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like, may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the security system 101 and/or one or more security devices may include one or more speakers 116. The speaker(s) 116 may be independent from other devices or integrated therein. For example, the camera(s) may include one or more speakers 116 (e.g., speakers 116a, 116b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit those audio sounds from the speaker(s) 116 located at the building 130. In an embodiment, one or more sounds may be output in response to detecting the presence of a human within an area. For example, the controller may cause the speaker may play one or more sounds selected to deter a detected person from an area around a building 130, environment 100, and/or object. The speaker, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The security system 101, one or more security devices, and/or the speakers 116, in some implementations, may be configured to store and/or has access to a library comprising a plurality of different sounds and/or a set of dynamically generated sounds so that the controller 106 may vary the different sounds over time, thereby not using the same sound too often. In some embodiments, varying and/or layering sounds allows a deter sound to be more realistic and/or less predictable.

One or more of the sounds may be selected to give a perception of human presence in the environment 100 or building 130, a perception of a human talking over an electronic speaker 116 in real-time, or the like which may be effective at preventing crime and/or property damage. For example, a library and/or other set of sounds may include audio recordings and/or dynamically generated sounds of one or more, male and/or female voices saying different phrases, such as for example, a female saying “hello?,” a female and male together saying “can we help you?,” a male with a gruff voice saying, “get off my property,” and then a female saying “what's going on?,” a female with a country accent saying “hello there,” a dog barking, a teenager saying “don't you know you’re on camera?,” and/or a man shouting “hey!” or “hey you!,” or the like.

In some implementations, the security system 101, one or more security devices, and/or the speaker 116 may dynamically generate one or more sounds (e.g., using machine learning and/or other artificial intelligence, or the like) with one or more attributes that vary from a previously played sound. For example, the security system, one or more security devices, and/or the speaker 116 may generate sounds with different verbal tones, verbal emotions, verbal emphases, verbal pitches, verbal cadences, verbal accents, or the like so that the sounds are said in different ways, even if they include some or all of the same words. In some embodiments, the security system 101, one or more security devices, the speaker 116 and/or a remote computer 125 may train machine learning on reactions of previously detected humans in other areas to different sounds and/or sound combinations (e.g., improving sound selection and/or generation over time).

The security system 101, one or more security devices, and/or the speaker 116 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The security system 101, one or more security devices, and/or the speaker 116, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the security system 101, one or more security devices, and/or the speaker 116 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the security system 101, one or more security devices, and/or the speaker 116 may play a primary sound layered and/or overlapping with one or more secondary, tertiary, and/or background sounds, varying the sounds and/or the combination from one or more previously played sounds and/or combinations, or the like.

The security system 101, one or more security devices, and/or the speaker 116, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic, such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The security system 101, one or more security devices, and/or the speaker 116, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the security system 101, one or more security devices, and/or the speaker 116 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the security system 101, one or more security devices, and/or the speaker 116 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101, one or more security devices, and/or the speaker 116 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

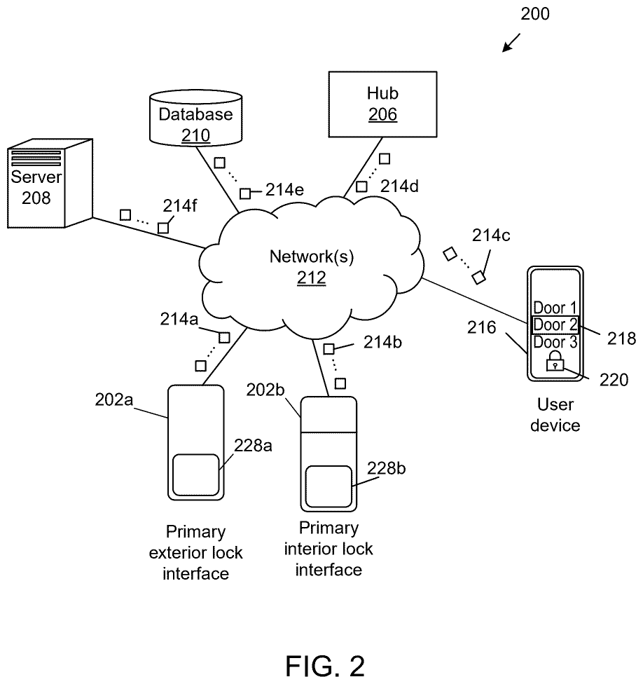

Turning now to FIG. 2, a system 200, including a smart lock for securing an enclosed space (e.g., a building) is shown, according to an embodiment. The system 200 may be located partially or entirely within the enclosed space. The enclosed space may be, for example, any building, edifice, or enclosure including one or more walls and one or more entrances. In the present disclosure, the building may include, but is not limited to, a home, office, store, business, courtyard, etc. The system 200 within and engaged to the building may include a primary exterior lock interface 202a, a primary interior lock interface 202b, and a hub 206 located internal and/or external from the space. The system 200 may further include a server 208, a database 210, one or more networks 212 (e.g., a local network may be part of the system 200 provided by the security system), and/or a user device 216. The various devices and components of the system 200 may communicate with one another via the one or more networks 212. The system 200 may be used to access, view, control, and/or adjust one or more locks of the doors that are engaged to the primary interior lock interface 202b from a single location exterior to the building (e.g., the primary exterior lock interface 202a). By way of example, and for ease of description, the single location exterior to the building may be a primary door, which may be a front door, a gate, or any other entrance of the enclosed space. According to some embodiments, the primary door may be a primary exit/entrance through which a user of the system 200 primarily exits/enters the building. In some embodiments, the primary door may be a garage door. In addition to the primary door, the enclosed space may include one or more secondary doors. Secondary doors may be entrances or exits from the building that do not serve as the user's primary means of entering/exiting the building. Secondary doors may include a side door, a side gate, a back door, a garage door, etc. Though the term “door” is used in various terms of the present disclosure, it should be understood that the any mechanism or means for entering/exiting the building may be encompassed in the term “door.” For example, “door” may encompass sliding doors, rotating doors, windows, gates, overhead doors, barn doors, etc.

For ease of description and understanding, FIG. 2 depicts the system 200 as having one or a small number of each component. Embodiments may, however, include additional or alternative components, or omit certain components, from those of FIG. 2 and still fall within the scope of this disclosure. As an example, it may be common for embodiments to include multiple servers 208 and/or multiple databases 210 that are communicably coupled to or operated by the server 208 and the primary exterior lock interface 202a through the network 212. Embodiments may include or otherwise implement any number of devices capable of performing the various features and tasks described herein. For instance, FIG. 2 depicts the database 210 as hosted as or operated as a distinct computing device from the server 208, though, in some embodiments, the server 208 may include an integrated database 210 hosted by the server 208.

The system 200 may include or utilize one or more networks 212, which may include any number of internal networks (e.g., LANs), external networks (e.g., WANs), private networks (e.g., intranets, VPNs), and public networks (e.g., Internet). The network(s) 212 may include various hardware and software components for hosting and conducting communications amongst the components of the system 200. Moreover, non-limiting examples of such internal or external networks 212 may include a Local Area Network (LAN), Wireless Local Area Network (WLAN), Metropolitan Area Network (MAN), Wide Area Network (WAN), and the Internet. The communication over the networks 212 may be performed in accordance with various communication protocols, such as Transmission Control Protocol and Internet Protocol (TCP/IP), User Datagram Protocol (UDP), and IEEE communication protocols, among others. Additional, and/or alternative communication protocols that may be used by the network(s) 212 may include Wi-Fi, Bluetooth, Zigbee, Z-Wave, Thread, Insteon, LoRaWAN, KNK, DALI, and/or UPnP.

The server 208 may include one or more processors that execute one or more software programs to perform various processes. The server 208 may include processor(s) and non-transitory, computer readable medium including instructions, which, when executed by the processor(s), cause the processor to perform methods disclosed herein. The processor(s) may include any number of physical, hardware processor. Although FIG. 2 shows only a single server 208, the server 208 may include any number of computing devices. In some cases, the computing devices of the server 208 may perform all or portions of the processes described herein to support the system 200. The server 208 may include computing devices (e.g., processors) operating in a distributed or cloud computing configuration and/or in a virtual machine configuration. It should also be appreciated that, in some embodiments, one or more functions of the server 208 may be partly or entirely performed by the primary exterior lock interface 202a or any other component (e.g., the hub 206).

The hub 206 may be communicatively coupled with the various components of the system 200 and/or other smart devices of the building directly or indirectly (e.g., through the network(s) 212, as shown in FIG. 2). By way of example, the hub 206 may receive control signals from, and transmit the control signals to, the primary exterior lock interface 202a or the primary interior lock interface 202b. The hub 206 may be configured to receive various communication protocol signals and translate the various communication protocol signals into control signals to control the various components of the system 200.

The primary exterior lock interface 202a (e.g., a controller) may be any type of electronic device including hardware components (e.g., one or more processors, non-transitory memory, user interface, housing, etc.) and software components capable of performing the various processes and tasks described herein. The primary exterior lock interface 202a may include a user input device for receiving instructions and interactions from the user. The primary exterior lock interface 202a may include an electronic display for presenting information to the user. By way of example, the primary exterior lock interface 202a may be distinct from the hub 206. Alternatively, the primary exterior lock interface 202a may perform the same or the similar functions as the hub 206. Non-limiting examples of the primary exterior lock interface 202a include smart home devices (e.g., smart locks), personal computers (e.g., laptop computers, desktop computers), server computers, mobile devices (e.g., smartphones, tablets), VR devices, and gaming consoles, smart watches, among other types of electronic devices. In an illustrative embodiment, the primary exterior lock interface 202a is configured to operate in conjunction with the primary interior lock interface 202b door lock so as to function as a smart lock for the primary door of the enclosed space. As will be described in greater detail below, the primary exterior lock interface 202a may include an electronic display, a user input device (e.g., keypad), a communications module (not shown), and a physical housing.

When installed, the primary exterior lock interface 202a may be mounted (e.g., located, installed, placed, attached, integrated) on the exterior of the primary door (e.g., positioned near or at a handle, lock, and/or doorknob). Alternatively, the primary exterior lock interface 202a may be mounted on a wall of the enclosed space. In general, the primary exterior lock interface 202a may be positioned anywhere that enables communications with the primary interior lock interface 202b wirelessly or via a wired connection.

The primary exterior lock interface 202a may include one or more computing devices (not shown) that execute one or more software programs to perform various processes. The primary exterior lock interface 202a may include a processor and non-transitory, computer-readable medium or memory including instructions, which, when executed by the processor, causes the processor to perform methods disclosed herein. The processor may include any number of physical, hardware processors that execute software to perform the functions described herein. The exterior lock interface 202a may include a bump knob 228a for use by a user to open a door on which the primary exterior lock interface 202a is mounted.

The primary interior lock interface 202b may be (or include) any type of electronic device comprising hardware components (e.g., one or more processors, non-transitory storage, etc.) and software executable by one or more processors capable of performing the various processes and tasks described herein. Non-limiting examples of the computing devices of the primary interior lock interface 202b include smart home devices (e.g., smart locks), personal computers (e.g., laptop computers, desktop computers), server computers, mobile devices (e.g., smartphones, tablets), VR devices, and gaming consoles, smart watches, among other types of electronic devices. The primary interior lock interface 202b may include a bump knob 228b for use by a user to open a door on which the primary interior lock interface 202b is mounted. The primary interior lock interface 202b may be mounted (e.g., located, installed, placed) on an interior of the primary door(s) and physically engage a portion of the door lock so as to control locking and unlocking the door lock, as further described herein.

The primary interior lock interface 202b may include one or more processors configured to execute one or more software programs to perform various processes. The primary interior lock interface 202b may include a processor and non-transitory, computer-readable medium including instructions, which, when executed by the processor, cause the processor to perform methods disclosed herein (e.g., causing a locking mechanism to transition from a locked state to an unlocked state, and vice versa). The processor may include any number and type of processors. In some cases, the computing devices of the primary interior lock interface 202b may perform at least a portion of the processes of the hub 206 and/or the primary exterior lock interface 202a. The primary interior lock interface 202b may also include various hardware mechanisms (e.g., actuators) to lock or unlock a mechanical, electromechanical, electromagnetic, or other type of lock of the primary door, as discussed in greater detail below. The primary exterior lock interface 202a and primary interior lock interface 202b may be in communication with one another such that a user who enters a command (e.g., unlock) into the interface 202a causes the interface 202b to perform an action (e.g., unlock the bump knob 228a).

The primary interior lock interface 202b may include one or more sensors (e.g., cameras, proximity sensors, radar, sonar, infrared, etc.) (not shown) to determine a presence of the user. Responsive to receiving an indication, from the one or more sensors, of the presence of the user, the indicators may display an indication of the sensed presence of the user. In certain embodiments, the primary exterior lock interface 202a also includes indicators that may function substantially in the same manner as the indicators of the primary interior lock interface 202b.

In addition to the primary interior lock interface 202b being configured to lock and unlock the door using the bump knob 228b, the primary interior lock interface 202b may include a specialized and/or configurable physical housing to position over a manual thumb turn of a deadbolt of a door. The primary interior lock interface 202b may include one more actuators that are electronically controlled to automatically switch states (e.g., lock or unlock) in response to received one or more control signals (e.g., from the primary exterior lock interface 202a, the hub 206, and/or the primary interior lock interface 202b). For example, the primary interior lock interface 202b may receive a control signal from the primary exterior lock interface 202a to transition a state of the primary door from an unlocked state to a locked state. Upon receiving the control signal at the primary interior lock interface 202b, the primary interior lock interface 202b actuates an actuator of the primary interior lock interface 202b to rotate the manual thumb turn (or the deadbolt directly) of the primary door into a locked position. In an alternative embodiment, the primary exterior lock interface 202a may receive the control signal or generate the control signal in response to a user interfacing directly with the primary exterior lock interface 202a and communicate the control signal to the primary interface lock interface 202b to cause the state of associated locks to change.

In some embodiments, the primary interior lock interface 202b may be configured to actuate the lock of a door in an alternative manner engaging a manual thumb turn of the lock (e.g., deadbolt) of the primary door. In such embodiments, the primary interior lock interface 202b may include an integrated deadbolt and/or be integrated into or on the primary interior door. The integrated deadbolt may be physically and/or mechanically coupled to one or more actuators of the primary interior lock interface 202b, and function to adjust a position of the integrated deadbolt from a locked or unlock position or vice versa. In integrated deadbolt embodiments, the primary interior lock interface 202b may function in substantially the same manner as the embodiments in which the primary interior lock interface 202b fits over the manual thumb turn. Upon the primary interior lock interface 202b transitioning from an unlocked state to a locked state or a locked state to an unlocked state, an indicator corresponding to the primary interior lock interface 202b may transition states (e.g., unlit to lit, lit to unlit, change colors, etc.), as well. Likewise, an indicator on each additional smart lock interface (for example the primary exterior lock interface 202a) adjust states as well. Upon the primary interior lock interface 202b changing lock states, especially if manually locked or unlocked, the primary interior lock interface 202b may transmit a signal indicative of the change of lock state.

In some embodiments, the primary exterior lock interface 202a may be configured to require a password authentication from the user through a user input of the primary exterior lock interface 202a. The password may depend on the type of user interface on the primary exterior lock interface 202a. If the user interface is a keypad (not shown), the password may be a sequence of digits. If a camera is on the primary exterior lock interface 202a, a facial recognition may be considered a password. Other biometrics, swipes, or passwords may be possible. Still yet, the exterior lock interface 202a may include a sensor configured to identify a device (e.g., RFID tags, RF signal generator, deadbolt device, inductive device, Bluetooth transmitter, etc.). Responsive to receiving a user input through the input of the primary exterior lock interface 202a, the primary exterior lock interface 202a may compare the user input to a stored (either locally or remotely) authenticator key. In response to the user input matching the stored authenticator key, the primary exterior lock interface 202a may be used to adjust the lock state of the exterior lock interface 202a. The primary exterior lock interface 202a may give one or more indications that the user input matches the stored authenticator key. For example, the primary exterior lock interface 202a may present an audible indication of a match (e.g., generate and output a tone), a visual indication of a match (e.g., turn on a light), and/or a haptic indication of a match.

The user device 216 (e.g., a mobile electronic device, such as a smartphone) may be any type of electronic device comprising hardware components (e.g., one or more processors, non-transitory storage medium, user interface) and software components capable of performing the various processes and tasks described herein. Non-limiting examples of the user device 216 include personal computers (e.g., laptop computers, desktop computers), server computers, mobile devices (e.g., smartphones, tablets), VR devices, and gaming consoles, smart watches, among other types of electronic devices. In an illustrative embodiment, the user device 216 is a mobile electronic device executing one or more mobile applications that are configured to communicate with (e.g., transmit to and receive from) the various components of the system 200. The user device 216 may include an electronic display, a user interface, communication electronics, and a physical housing.

The user device 216 may include one or more computing devices configured to execute one or more software programs (e.g., mobile applications or apps) to perform various processes. In some embodiments, the user device 216 may be a computer or computing device capable of performing the same or similar methods disclosed herein as performed by the user device 216. The user device 216 may include a processor and non-transitory, computer-readable medium including instructions, which, when executed by the processor, causes the processor to perform methods disclosed herein. Although FIG. 2 shows only a single user device 216, the user device 216 any include any number of devices associated with one or more users. In some cases, the computing devices of the user device 216 may perform at least a portion of the processing processes of the primary exterior lock interface 202a, the primary interior lock interface 202b, and/or the hub 206. Moreover, the user device 216 may support processes and/or interact with any of the

By way of example, the user of the system 200 may interact with the user device 216 to select one or more selectable elements 218 or buttons (each element 218 may be associated with a corresponding smart lock/door) to adjust from a first state (e.g., unlocked) to a second state (e.g., locked). The user may then select the element 220 to indicate whether to adjust the corresponding smart lock/door from the first state to the second state or the second state to the first state. In response to receiving the indications of the selected elements 218, 220, the user device 216 transmits control signals (either directly or indirectly) to the various locks/doors corresponding to the selected element 218 to execute the indicated transition between states as indicated by the selected elements 218, 220. In an embodiment, rather than having to interact with multiple elements 218, 220, the elements 218 may control both selection and state of the smart lock/door by, for example, holding the element 218 for a certain period of time or tap an element multiple times within a maximum time period (e.g., 2 taps within 0.5 seconds). Other user interface elements and processes for interacting with these elements may be provided and utilized in performing the locking and unlocking.

Control and informational signals may be transmitted between the components of the system 200. For example, the signals 214a, 214b, 214c, 214d, 214e, and/or 214f (collectively 214), may be transmitted between and amongst components through the network(s) 212. As described herein, the signals 214 may be transmitted utilizing any suitable communication protocol. According to illustrative embodiments, the signals 214a-214f may be transmitted directly between components of the system 200. Alternatively, or additionally, the signals 214 may be transmitted from a smart lock in response to a user changing a lock state thereof or to a single component (e.g., the hub 206 and/or the primary exterior lock interface 202a) and then relayed from the single component to one or more other components of the system 200.

### Hands Free Bump Knob

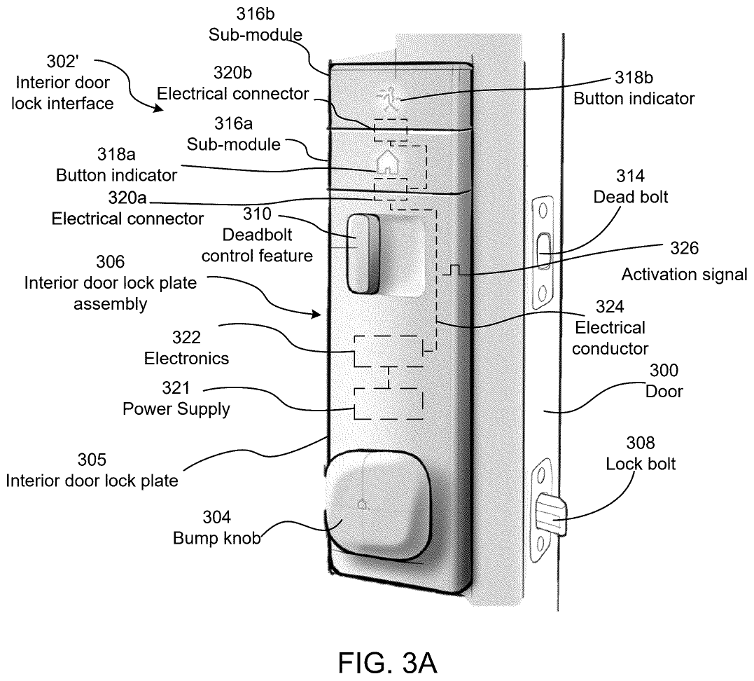

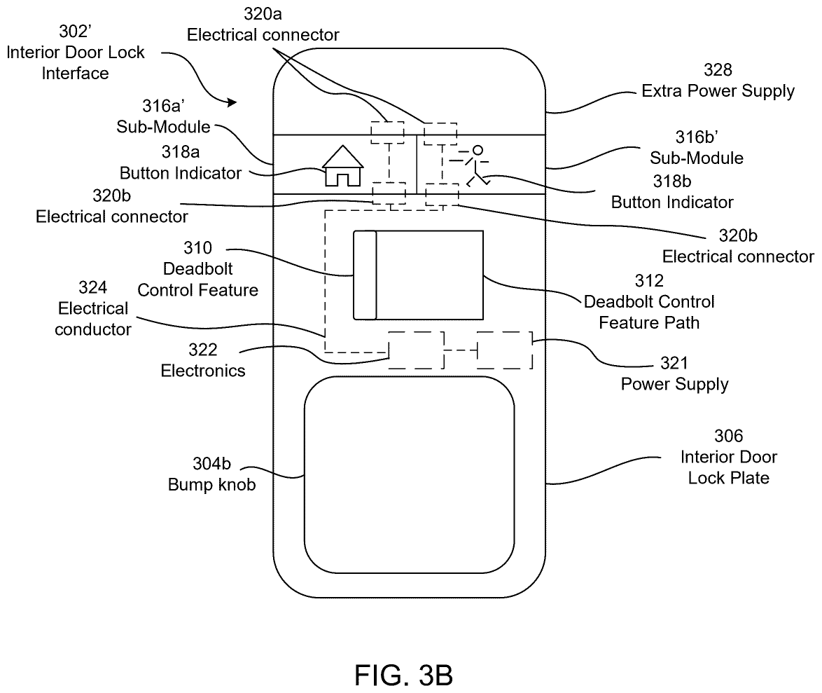

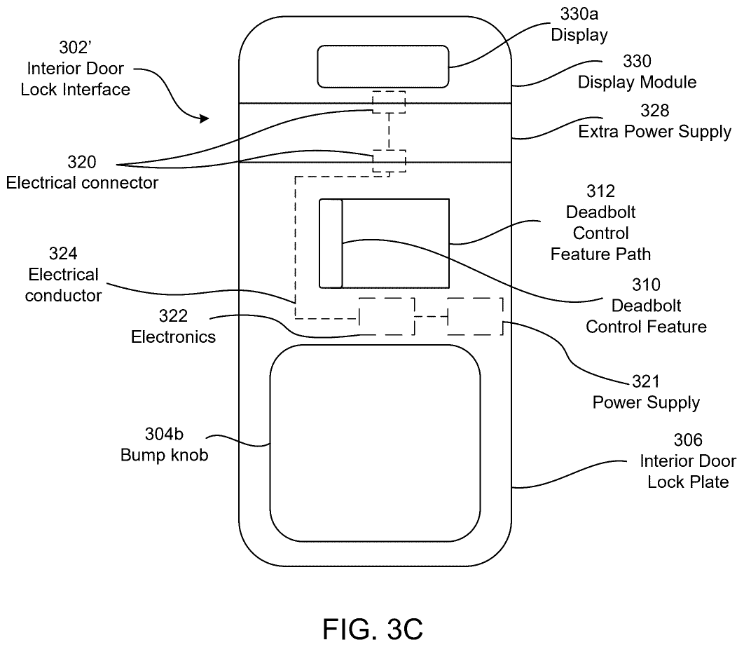

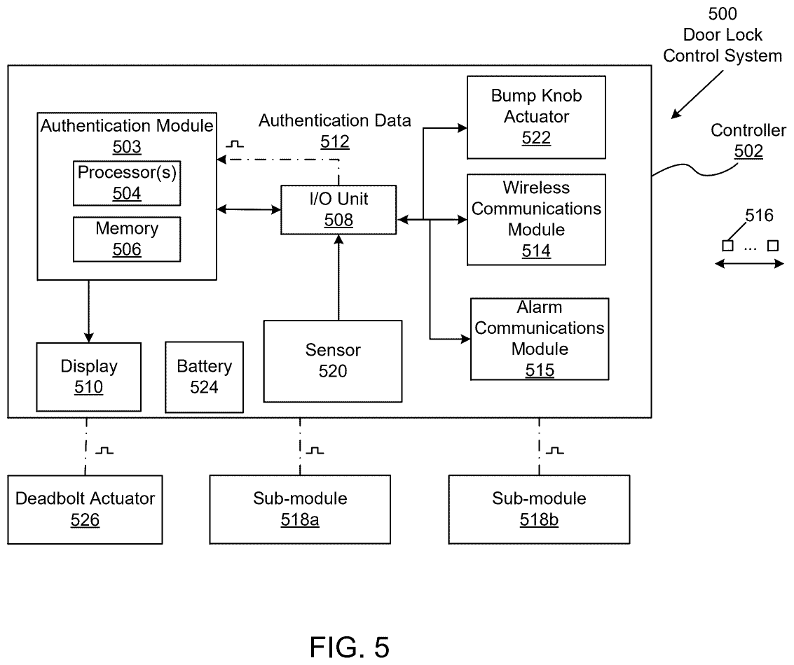

Reference is now made to FIG. 3A, which depicts an embodiment of an interior door lock interface 302 which may be installed or affixed to an interior surface of the door 300. As shown, the interior door lock interface 302 may include an interior door lock plate assembly 306 which includes a door lock plate 305, a hands-free bump knob 304 configured to transition a lock bolt 308 from a non-retracted state to a retracted state, a deadbolt control feature 310 may be configured to move along a deadbolt control feature path 312 to transition a deadbolt 314 from a locked state to an unlocked state and vice versa, and various sub-modules 316a, 316b. The door lock plate assembly 306 may define an interior portion that may house or otherwise support electrical components mounted thereto. The door 300 may include a lock bolt 308 and a deadbolt 314. The door 300 may be positioned in an open state or a closed state. The open state of the door 300 refers to a state where a person or entity may pass through the doorway unimpeded by the door 300 itself, whereas the closed state of the door 300 refers to a state where the door 300 is positioned about the doorway in a manner such that a person or entity may not pass through the doorway. The door lock plate assembly 306 may also include a power supply 321, electrical connectors 320a, 320b (collectively 320), electronics 322, an electrical conductor 324 configured to electrically and communicatively couple the components of the interior door lock interface 302 to one another, and an activation signal 326. Electronics 322 may include the components depicted and described in relation to a door lock control system 500 as shown and described in relation to FIG. 5. Electronics 322 may also include one or more processors, one or more non-transitory memory modules, a wireless communication module, an antenna, a solenoid, or any other suitable or desirable component.

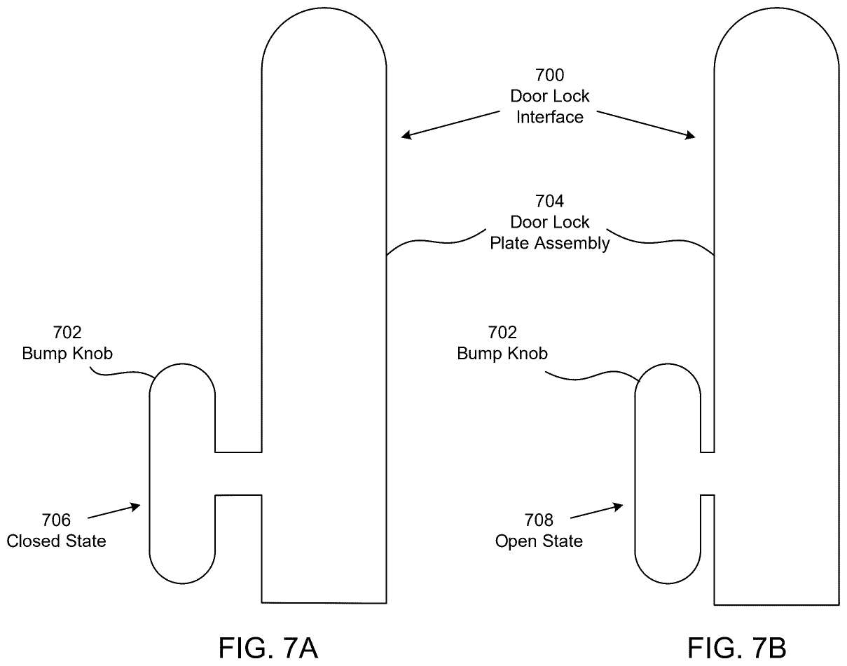

In operation, the hands-free bump knob 304 is positioned about the door lock plate assembly 306 and may be moved towards the door lock plate assembly 306 when actuated or transitioned from a closed state to an open state, as shown in FIGS. 7A and 7B and the accompanying description below. The hands-free bump knob 304 is mechanically communicatively coupled to the lock bolt 308 such that when the hands-free bump knob 304 is pressed, pushed, or otherwise transitioned to the open state from the closed state, the lock bolt 308 transitions to a retracted state from a non-retracted state. If the user has not been authenticated, then the hands-free bump knob 304 may be maintained in a locked stated or may be transitioned to the open state from the closed state without transitioning or altering the state of the lock bolt 308.

With continued reference to FIG. 3A, the lock bolt 308 may be positioned in a retracted state, a non-retracted state, or any other suitable intermediary state between retracted and non-retracted. When the door 300 is in a closed state or position and the lock bolt 308 is in the non-retracted state (i.e., extending from the door 300), the door 300 is prevented from transitioning to an open state by the lock bolt 308 positioned in the non-retracted state being retained by a corresponding latch bore. In such a position, the lock bolt 308 extends into a corresponding latch bore or hole configured to accept or receive the lock bolt 308 in the non-retracted state when the door 300 is in the closed state. When the lock bolt 308 is transitioned to the retracted state, the lock bolt 308 retracts from the corresponding hole and into the door 300, as such the door 300 may be opened (i.e., transitioned to an open state).

The deadbolt 314 may be actuated or transitioned from a locked state to an unlocked state. When in the unlocked state, the deadbolt 314 may retracted into a cavity defined by the door 300, thereby allowing the door 300 to be transitioned to the open state if the lock bolt 308 is also in the non-retracted state. The deadbolt 314 is communicatively mechanically coupled to deadbolt control feature 310 (e.g., slide grip, horizontal thumb turn, etc.), which follows path 312. When the deadbolt control feature 310 is positioned about the left side of path 312, then the deadbolt 314 may be positioned in the unlocked state. When the deadbolt control feature 310 is positioned about the right side of path 312, then the deadbolt 314 may be in the locked state. The deadbolt control feature 310 can be configured to transition from one side of the path 312 to the other manually, automatically (i.e., without requiring user input), or semi-automatically (e.g., with user command in some manner). For example, the deadbolt control feature 310 can be configured to transition the deadbolt 314 from the unlocked state to the locked state every time that the door 300 is closed or shut. The deadbolt control feature 310 can be configured to only transition the deadbolt 314 to the locked state with the manual input of a user such that the user must grasp the deadbolt control feature 310 and physically transition the deadbolt control feature 310 from one side of the path 312 to the other. Such a physical transition of the deadbolt control feature 310 simultaneously transitions the deadbolt 314 from a locked state to an unlocked state, and vice versa.

With continued reference to FIG. 3A, sub-modules 316a, 316b (collectively 316) may be electrically coupled to the interior door lock interface 302 by electrical connectors 320a, 320b (collectively 320) and may be configured to initiate certain functions using a pre-programmed set of commands executed by one or more processors or other electronics. Sub-modules 316 may be mechanically, electrically, and/or communicatively coupled to the door lock plate assembly 306 and are configured to add additional functionality to the interior door lock interface 302. Sub-module 316 can have an identifying logo, mark, or button indicator 318a, 318b (collectively 318) to identify and support the functionality of the respective sub-modules 316. As another example, sub-module 316a is presently depicted with a button indicator 318a that is a home to indicate that sub-module 316a performs a function related to a person returning to the home or premises (e.g., deactivating an alarm system). As another example, sub-module 316b is presently depicted with a button indicator 318b that is a person walking to indicate that sub-module 316b performs a function related to a person leaving the home or premises (e.g., activating an alarm system). Such commands could relate to associated internet of things (IoT) connected devices, such as smart lights or blinds, and be configured to turn ON or OFF certain smart lights and/or raise or lower certain smart blinds. Pressing or actuating either sub-module 316, can request or initiate a command to transition the deadbolt control feature 310 from one side of the path 312 to the other.

Reference is now made to FIGS. 3B-3C, which respectively depict an alternative embodiment of an interior door lock interface 302′. The embodiments depicted in FIGS. 3B-3C may include similar components configured to perform similar functions as the embodiment of depicted in FIG. 3A with differences and distinctions described herein. The embodiment depicted in FIG. 3B has or includes sub-modules 316a′ and 316b′ (collectively 316′) and an extra power supply module 328 mechanically coupled to the interior door lock plate assembly 306. Extra power supply module 328 is electrically coupled to and supplies power for the various components of the interior door lock interface 302. Extra power supply module 328 can be a removable battery or an integrated power supply that is not configured to be removed. In FIG. 3B, sub-modules 316′ are depicted as each having a width of approximately half the width of the door lock plate assembly 306. With sub-modules 316′ only half of the width of the door lock plate assembly 306, this allows for more sub-modules 316′ to be installed or affixed to the interior door lock interface 302 within a similar height as an interior door lock interface 302 having half as many sub-modules 316 that have a width that is the same as the door lock plate assembly 306.

The embodiment depicted in FIG. 3C may include an extra power supply module 328 and a display module 330 having a display 330a, both mechanically, electrically, and communicatively coupled to the interior door lock plate assembly 306 via the electrical connector 320. The extra power supply module 328 is electrically communicatively coupled to the display module 330 and the various components of the interior door lock interface 302′ via the electrical connectors 320. The extra power supply module 328 can be positioned as a top module, where it is configured to couple to another sub-module 316 or directly to the door lock plate assembly 306 via electrical connector 320. As shown in FIG. 3C, the extra power supply module 328 can also be configured as a body module that is configured to be coupled to at least two other modules, one above and below the extra power supply module 328. In some implementations, a top module can be supplied to couple to the top end of a body module, thereby functionally converting the body module into a top module.

The display module 330 may include a display 330a that is configured to display different types of information that may be relevant to a user, such as the current deadbolt status, a length of time that the interior door lock interface 302 has been on that status, a length of time from the last status change, who was the user that most recently caused a status change, administrative or system notifications, such as “charge battery” or “update firmware,” or any other information that is suitable or desirable to be displayed on the display 330a. The display 330a can also be configured to depict or display whether or not the most recent authentication attempt was successful and which user was authenticated. It should be understood that certain implementations of the interior door lock interface 302 may include a single display, a display positioned in the interior of the building or premises, and a display positioned on the exterior of the building or premises, no display, or any other suitable or desirable configuration for the number of and positioning of display the 330a.

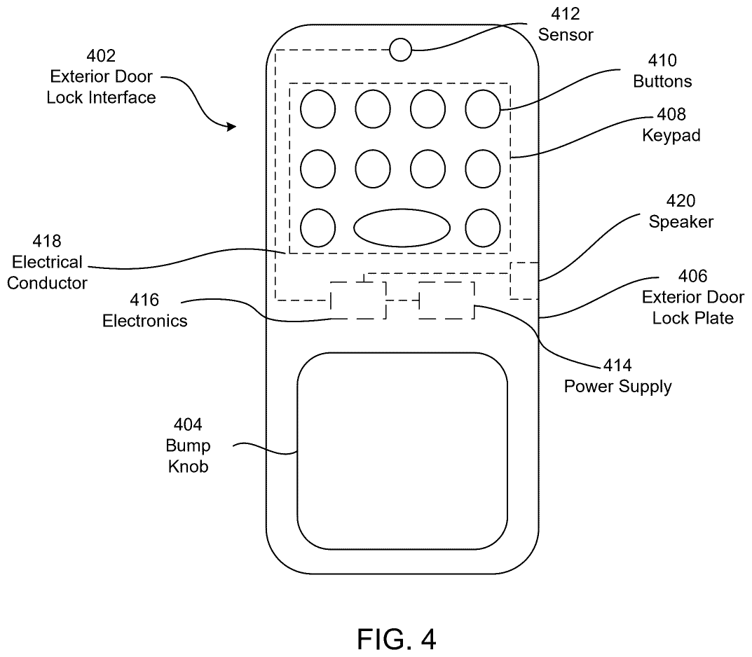

Reference is now made to FIG. 4, which depicts a block diagram front side plan view of an exterior door lock interface 402, is shown. The exterior door lock interface 402 may include a hands-free bump knob 404, an exterior door lock plate 406, a keypad 408 with buttons 410, and a sensor 412. The exterior door lock interface 402 may also include a power supply 414, electronics 416, and an electrical conductor 418 configured to electrically and communicatively couple the components of the exterior door lock interface 402 to one another. The exterior door lock interface 402 may have similar components with similar names, having similar functions, to the interior door lock interface 302 of FIG. 3A, as described above.

In operation, the hands-free bump knob 404 is positioned about the exterior door lock plate 406 and can be moved towards the exterior door lock plate 406 when actuated or transitioned from a closed state to an open state. The hands-free bump knob 404 is mechanically communicatively coupled to a lock bolt, such as lock bolt 308 of FIG. 3A, such that when the hands-free bump knob 404 is pressed, pushed, or otherwise transitioned to the open state from the closed state, the lock bolt 308 transitions to a retracted state from a non-retracted state. If a user has been authenticated, then the hands-free bump knob 404 may be set to an unlocked state that enables the user to press the hands-free bump knob 404 so as to transition the lock bolt 308 to the retracted state (i.e., the bump knob 404 transitions from the closed state to the open state). If the user has not been authenticated, then the hands-free bump knob 404 may be maintained in a locked stated or may be transitioned to the open state from the closed state without transitioning or altering the state of the lock bolt 308.

The sensor 412 can be an image sensor configured to capture still photographs or video data. In some implementations, the sensor 412 can be configured to capture a still photo of a user and then compare the face of the user in the captured image to a verified, sample image or facial key points of the user to authenticate the user. Facial recognition software may be executed by the electronics 416 of the exterior door lock interface 402 or remotely located therefrom. If the facial data captured by the sensor 412 matches the facial data contained within the verified, sample picture, then the user may be authenticated, allowing the deadbolt 314 (not shown) to be transitioned to the unlocked state and engaging the hands-free bump knob 404 with the lock bolt 308 of FIG. 3A such that when the hands-free bump knob 404 is transitioned to the open state, the lock bolt 308 transitions to the retracted state. It should be understood, that while sensor 412 may be presently depicted as an image sensor, other configurations are also envisioned. For example, sensor 412 can be a biometric sensor configured to accept or receive a scan of a user's fingerprint for comparing against a verified, known scan of the user's fingerprint.

Biometric or fingerprint recognition software may be executed by the electronics 416 on the exterior door lock interface 402 or remotely therefrom. Sensor 412 can also be a microphone configured to receive or sense a spoken password or passcode from a user. Such audible authentication data can be voice recognition data, such that the exterior door lock interface 402 may authenticate a user if the user's voice can be recognized when compared to a known voice file sample. The audible authentication data can also be an audible PIN, keycode, password, or any other suitable or desirable audible authentication data that can be spoken or otherwise generated by a user. Voice recognition software may be executed by the electronics 416 on the exterior door lock interface 402 or remotely therefrom. Sensor 412 can be any other suitable or desirable type or category of sensor 412.

Electronics 416 may include the components depicted and described in relation to the door lock control system 500 as shown and described in relation to FIG. 5. Electronics 416 may also include one or more processors, one or more memory modules, a wireless communication module, an antenna, a solenoid, a battery, a camera, an inductive or capacitive sensor, or any other suitable or desirable component. Electronics 416 can be configured to receive a user's authentication data that is used to authenticate the user. The electronics 416 can also be configured to receive a radio frequency identification (“RFID”) authentication data. A user can have an RFID-enabled tag in the form of a keycard, token, keychain, or any other suitable component capable of containing, carrying, or otherwise transmitting an RFID signal. In such implementations, a user may place or position the RFID-enabled tag or token proximate to the electronics 416 such that the electronics 416 can receive the RFID signal. RFID recognition software may be executed by the electronics 416 on the exterior door lock interface 402 or remotely therefrom. The electronics 416 can also be configured to receive authentication data transmitted wirelessly to the electronics 416. Such authentication data can be transmitted via Bluetooth, Wi-Fi, or any other suitable or desirable type of wireless data transmission. In such implementations, a user can approach the exterior door lock interface 402 with a Bluetooth or Wi-Fi enabled device close enough such that the electronics 416 can connect to or otherwise receive authentication data via the Bluetooth or Wi-Fi connection with the user's Bluetooth or Wi-Fi enabled device.

The keypad 408 can also have or include status lights that can actuate, turn on, or change color in response to electronics 416 receiving authentication data from a user. For example, the keypad 408 can have buttons 410 with backlighting that flashes green if valid authentication data is received from the user and red if invalid authentication data is received from the user. The exterior door lock interface 402 may also include a speaker 420 configured to provide audio feedback to the user when authentication data is received. For example, the speaker 420 can be configured to produce a message to the user when invalid authentication data is received such as “invalid PIN,” “invalid keycode,” “invalid authentication data,” or any other suitable or desirable audio message to be delivered to the user when invalid authentication data is received. The speaker 420 can also be configured to provide any other suitable or desirable administrative messages such as “charge battery,” “update firmware,” or any other suitable or desirable audible message that may be delivered to a user.

In some implementations, the exterior door lock interface 402 can be configured to authenticate a user when the exterior door lock interface 402 has received multiple disparate types of authentication data by including two or more different types of sensors 412 and processing and matching two different sets of authentication data. For example, the exterior door lock interface 402 may authenticate a user when the user provides at least two types or categories of authentication data that matches verified authentication data for the user. The disparate types or categories can be a keycode entered on, with, at, or about the keypad 408, facial recognition authentication data received from sensor 412, and/or voice authentication data. It should be understood that the exterior door lock interface 402 can be configured to capture multiple disparate forms of authentication data prior to authenticating a user. The keypad 408 may include buttons 410 with numbers, letters, or other marking affixed thereon. The buttons 410 can be physical buttons that can be moved or depressed when pushed, the buttons 410 can also be software-generated buttons displayed on a touch sensitive display (not shown) that do not cause any movement of the button 410 when pushed or actuated.

Reference is now made to FIG. 5, a block diagram of an embodiment of a door lock control system 500 is shown. The door lock control system 500 may include a controller 502 having an authentication module 503 that includes one or more processors 504 and one or more non-transitory memory modules 506. The controller 502 may further include at least one input/output (“I/O”) unit 508 communicatively coupled to the authentication module 503, a wireless communications module 514, an alarm communications module 515, and/or a bump knob actuator 522. The controller 502 may further include a display 510 communicatively coupled to the authentication module 503, a sensor 520, and a battery 524. The door lock control system 500 may also be communicatively coupled to one or more sub-modules 518a-518b (collectively 518) and/or a deadbolt actuator 526.

The authentication module 503 is communicatively coupled to the I/O unit 508 and the display 510. The authentication module 503 is configured to receive authentication data 512 from the sensor 520 via I/O unit 508. The authentication module 503 may include one or more processors 504 and non-transitory, computer-readable medium including instructions, which, when executed by the processors 504, cause the processor(s) 504 to perform methods disclosed herein (e.g., causing a locking mechanism to transition from a locked state to an unlocked state, and vice versa). The processor(s) 504 may be configured to compare the authentication data 512 to known user authentication data stored in the memory 506 or in a data repository located remotely from the controller 502. If the authentication data 512 matches with a known user authentication data stored in the memory 506 (or the remote data repository), then the authentication module 503 may authenticate the user. Once a user has been authenticated, the bump knob actuator 522 may be instructed and/or driven to transition the hands-free bump knob (304, 404, 702) to the unlocked state, allowing the hands-free bump knob (304, 404, 702) to be transitioned from the closed state to the open state such that the lock bolt 308 (not shown) may be transitioned from a non-retracted state to a retracted state. In some embodiments, in the locked state, the hands free bump knob (304, 404, 702) may be prevented from being pressed towards the door lock plate while in other embodiments, the hands-free bump knob (304, 404, 702) may be mechanically decoupled from the lock bolt 308 (not shown) such pressing the hands free bump knob toward the door lock plate does not result in the lock bolt 308 (not shown) transitioning from the non-retracted state to the retracted state. It should be understood, that while the bump knob actuator 522 is presently depicted as being integrated with or an integral component of the controller 502, other configurations are also envisioned. For example, the bump knob actuator may be a component external to the controller 502 while still being communicatively and electrically coupled to the controller 502. Alternatively, or additionally, when a user is authenticated, the deadbolt actuator 526 actuates to cause a deadbolt control feature (e.g., deadbolt control feature 310 of FIG. 3A) to move along the deadbolt control feature path (e.g., deadbolt control feature path 312) to transition the deadbolt (e.g., deadbolt 314) from the locked state to the unlocked state. It should be understood, that while the deadbolt actuator 526 is presently depicted as being a component external to the controller 502, while still being communicatively and electrically coupled to the controller 502, other configurations are also envisioned. For example, the deadbolt actuator 526 may be integrated with or an integral component of the controller 502. It should also be understood that the deadbolt actuator 526 may be configured to respond independently.

The sensor 520 may be an image sensor configured to capture still photographs or video data. In some implementations, the sensor 520 can be configured to capture a still photo of a user and then compare the face of the user in the captured image to a verified, sample image or facial key points of the user to authenticate the user. Facial recognition software may be executed by the authentication module 503 or remotely therefrom. If the facial data captured by the sensor 520 matches the facial data contained within the verified, sample picture, then the user may be authenticated, allowing the deadbolt 314 to be transitioned to the unlocked state and engaging the hands-free bump knob (304, 404, 702) with the lock bolt 308 such that when the hands-free bump knob (304, 404, 702) is transitioned to the open state, the lock bolt 308 transitions to the retracted state. Sensor 520 may be a biometric sensor configured to accept or receive a scan of a user's fingerprint for comparing against a verified, known scan of the user's fingerprint by the authentication module 503. Biometric or fingerprint recognition software may be executed by the authentication module 503 or remotely therefrom. Sensor 520 can also be a microphone configured to receive or sense a spoken password or passcode from a user. Such audible authentication data can be voice recognition data, such that the authentication module 503 will authenticate a user if the user's voice can be recognized when compared to a known voice file sample. The audible authentication data can also be an audible PIN, keycode, password, or any other suitable or desirable audible authentication data that can be spoken or otherwise generated by a user. Voice recognition software may be executed by the authentication module 503 or remotely therefrom. Sensor 520 can be any other suitable or desirable type or category of sensor.

In some implementations, the authentication module 503 may authenticate a user if multiple disparate types or categories of authentication data 512 are received. For example, authentication module 503 can be configured to only authenticate a user if a valid keycode is entered and a valid biometric reading is received by sensor 520, and their respective authentication data (or singular datum) 512 received at the authentication module 503. It should be understood that while the authentication module 503 can be configured to authenticate a user when two or more different types or categories of authentication data 512 are received and verified (e.g., matched), other configurations are also envisioned.

The wireless communications module 514 may be configured to receive data (i.e., a plurality of datum) 516 transmitted via a wireless transmission means, including Wi-Fi, Bluetooth®, Zigbee®, or any other suitable or desirable wireless transmission protocol. The wireless communications module 514 can be configured to communicate the data 516 to the authentication module 503 if the data 516 is authentication data 512. The wireless communications module 514 can also be configured to wirelessly transmit information regarding the interior or exterior door lock interface 302, 402, 700 (collectively 700). Such information can include the current status of the door lock interface 700, a timestamp of the previous change of the status, the authentication data 512 utilized or accepted to change such status of the door lock interface 700, the user who is associated with the authentication data 512 utilized or accepted to change such status of the door lock interface 700, or any other suitable or desirable information that can be transmitted by the wireless communications module 514.

With continued reference to FIG. 5, the authentication module 503 may also be communicatively coupled to an electronic display 510. When the authentication module 503 authenticates a user, the authentication module 503 may be configured to transmit a signal to request that the display 510 output or depict a word, message, logo, picture, or any other suitable or desirable visual communication to indicate that the user has been authenticated. For example, after a user is authenticated by the authentication module 503, the display 510 can be configured to display the message “unlocked,” “authenticated,” “enter,” or any other suitable or desirable message. As another example, after a user is authenticated by the authentication module 503, the display 510 can be configured to display a green colored check mark or it depiction of an open door, or any other suitable or desirable visual communication to indicate that the user has been authenticated. Similarly, if the authentication module 503 does not authenticate a user, the authentication module 503 can be configured to transmit a signal to request that the display 510 output or depict a word, message, logo, picture, or any other suitable or desirable visual communication to indicate that the user has not been authenticated. For example, after a user has not been authenticated by the authentication module 503, the display 510 can be configured to display the message “locked,” “invalid authentication credentials,” or any other suitable or desirable message to communicate that the user's credentials have not been accepted or authenticated by the authentication module 503. As another example, after a user has not been authenticated by the authentication module 503, the display 510 can be configured to display a red colored “X,” a depiction of a closed door, a depiction of a lock that is locked, or any other suitable or desirable visual communication to indicate that the user has not been authenticated by the authentication module 503.

Controller 502 may also be communicatively coupled to sub-modules 518a, 518b (collectively 518). When a request or command is entered add or received by sub-modules 518 the controller 502 can be configured to execute the request or command received by sub-modules 518. For example, sub-module 518a can be configured to be a set of commands or requests associated with the user leaving the premises. As such, when optional sub-module 518a is pressed or executed by the user, the controller 502 can be configured to transmit a signal to the alarm communications module 515, or via the wireless communications module 514, to an external or otherwise associated security system such that the security system is transitioned to an armed, activated, or ON state, as well as transitioning the deadbolt 314 to a locked state the next time that the door 300 is closed or otherwise in a closed state, or any other suitable or desirable command or action to be executed by associated IoT devices. As a further example, sub-module 518b can be configured to be a set of commands or requests associated with the user entering the premises. As such, when sub-module 518b is pressed or executed by the user, the controller 502 can be configured to transmit a signal to the alarm communications module 515, or via the wireless communications module 514, to an external or otherwise associated security system such that the security system is transitioned to a disarmed, deactivated, inactivated, or OFF state, as well as transitioning the deadbolt 314 to a locked or unlocked state the next time that the door 300 is closed or otherwise in a closed state, or any other suitable or desirable command or action to be executed by associated IoT devices.

Bump knob actuator 522 may be configured as being integral with the controller 502 as shown, or as an associated component that is electrically and/or communicatively coupled to the controller 502.

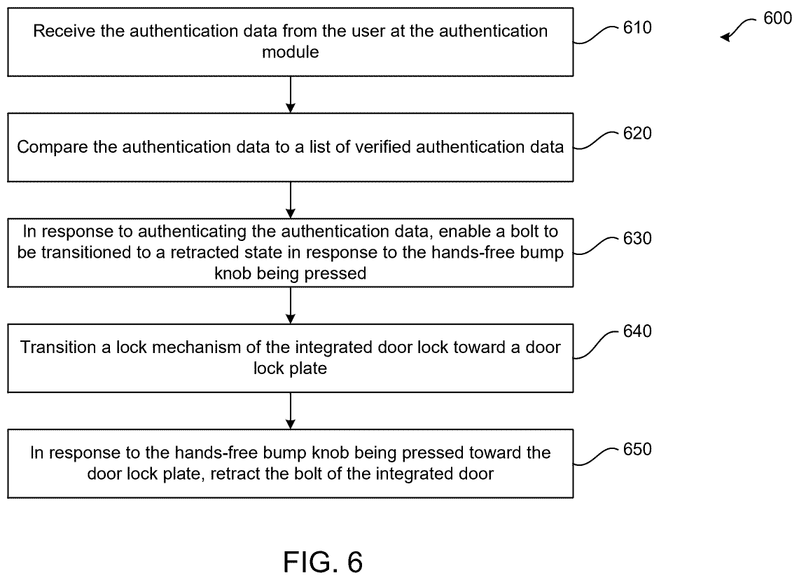

Reference is now made to FIG. 6, a block flow diagram of an embodiment of a method 600 of operating an integrated door lock is shown. At step 610, the process may receive, by an authentication module of a door lock interface coupled to an exterior side of a door, authentication data from a user. The authentication data may include a keycode, fingerprint, facial image, etc. At step 620, the authentication data may be compared to a list of stored authentication data. The list of stored authentication data may include a list of one or more types of authentication data associated with one or more users, such as residents, who access the integrated door lock to enter a door on which the integrated door lock is attached and used for locking the door. At step 630 in response to authenticating the authentication data, the integrated door lock with a hands-free bump knob, for example, may be configured to enable the user to transition a bolt to a retracted state in response to the user pressing the hands-free bump knob. At step 640, the bolt may be retracted in response to the hands-free bump knob transitioning from a closed state (i.e., in a resting, unpressed state) to an open state (i.e., fully pressed in). It should be understood that while the steps 610, 620, 630, and 640 are depicted sequentially, the steps 610, 620, 630, and 640 may be completed in any suitable or desirable order. Moreover, additional and/or alternative steps may be utilized. In an embodiment, one or more of the steps may be eliminated while maintaining a viable solution for performing the overall process of the process 600.

FIG. 7A is an illustration that depicts an illustrative door lock interface 700 with a hands-free bump knob 702 depicted in a closed state 706. The closed state 706 of the hands-free bump knob 702 refers to a state where the hands-free bump knob 702 is extended away from a door lock plate assembly 704 and a lock bolt, such as lock bolt 308 of FIG. 3A, is in a non-retracted state. If the door is not closed, the hands-free bump knob 702 may be in a closed state, as well. If a door is closed and the lock bolt is aligned by a latch bore (not shown), the lock bolt would be retained by a latch bore to maintain the door in a closed state.

FIG. 7B is an illustration that depicts the door lock interface 700 with the hands-free bump knob 702 depicted in an open state 708. The open state 708 of the hands-free bump knob 702 refers to the state where the hands-free bump knob 702 is pressed or pushed towards the door lock plate assembly 704 such that the door bolt is in a retracted state so as to be withdrawn from the latch bore, if the door is in a closed state, or simply retracted into the door lock interface 700.

### Rechargeable Energy Source of Door Lock via the Door Lock Strike Plate

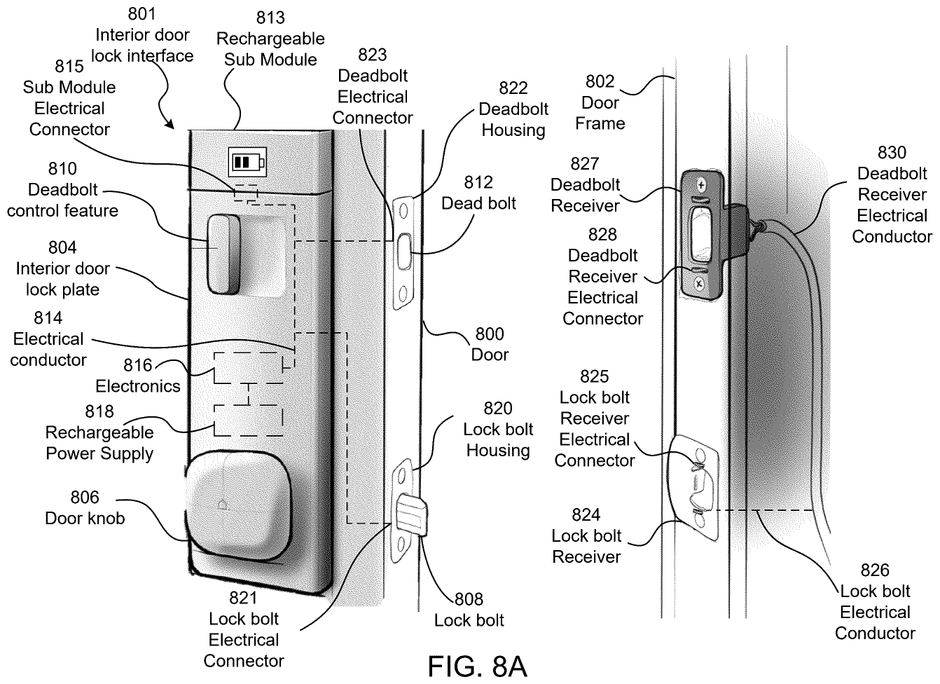

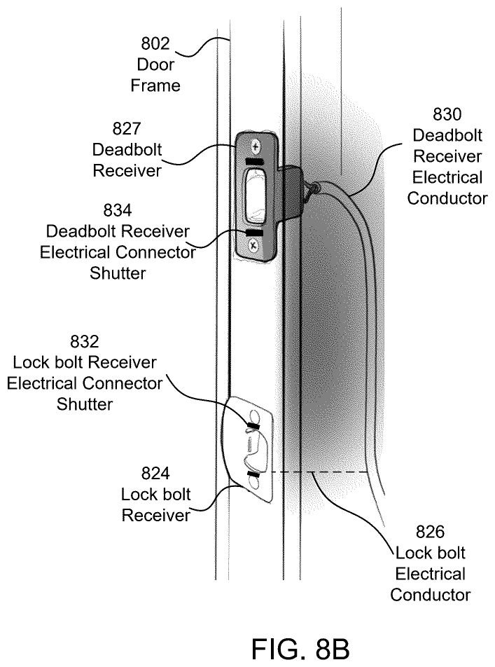

Reference is now made to FIG. 8A, which is an illustration that depicts an embodiment of an interior door lock interface 801 that may be installed or affixed to an interior surface of the door 800. As shown, the interior door lock interface 801 includes an interior door lock assembly 804, a door knob 806 configured to transition a lock bolt 808 from a non-retracted state to a retracted state, a deadbolt control feature 810 configured to transition a deadbolt 812 from a locked state to an unlocked state and vice versa, a rechargeable battery sub-module 813, an electrical conductor 814, and a sub-module electrical connector 815. The electrical conductor 814 electrically conducts electrical energy and may be configured to electrically connects various electrically powered components of the interior door lock interface 801 to one another. For example, the sub-module electrical connector 815 electrically and communicatively connects the rechargeable sub-module 813 to the interior door lock plate assembly 804, specifically to the electrical conductor 814. The rechargeable battery sub-module 813 may include a rechargeable battery or other rechargeable energy source. The interior door lock interface 801 may also include electronics 816, a rechargeable power supply 818, a lock bolt electrical connector 821, a deadbolt electrical connector 823. The electrical connectors 821 and/or 823 may be configured as integral with or otherwise coupled to the lock bolt housing 820 and/or the deadbolt housing 822, respectively. Electronics 816 may include components depicted and described in relation to the door lock control system 500 as shown and described in relation to FIG. 5. As an example, the electronics 816 may include one or more processors, one or more non-transitory memory modules, a wireless communication module, an antenna, a solenoid, or any other suitable or desirable component to support the functions described hereinabove. In an embodiment, the electronics 816 may include a conditioning circuit (e.g., debounce circuit, clamp, buffer, etc.) to avoid power surges or other undesirable electrical power effects due to opening and closing in ways that cause the electrical connectors 821 and/or 823 to have electrical arcing with a corresponding electrical connector supplying electrical energy to the electrical connectors 821 and/or 823.

The door frame 802 may include a lock bolt receiver 824, a lock bolt receiver electrical connector 825 connected to a lock bolt electrical conductor 826, a deadbolt receiver 827, a deadbolt receiver electrical connector 828 connected to a deadbolt receiver electrical conductor 830. The deadbolt receiver electrical conductor 830 and the lock bolt electrical conductor 826 may be electrically connected to one another or may be separate and distinct electrical conductors. The electrical conductors 826, 830 are configured to transfer, communicate, or otherwise conduct electrical energy to the lock bolt receiver electrical connector 825 and/or the deadbolt receiver electrical connector 828. The lock bolt receiver 824 and/or the deadbolt receiver 827 may be configured as a strike plate.

In operation, while the door 800 is in the closed state, the deadbolt receiver 827 is aligned with the deadbolt 812 such that the deadbolt 812 may be received in the aperture or opening of the deadbolt receiver 827. While in the closed state, the deadbolt receiver electrical connector 828 is aligned with or otherwise in close proximity to the deadbolt electrical connector 823 such that electrical energy may be transferred by electrical conduction or induction, for example, from the deadbolt receiver electrical connector 828 to the deadbolt electrical connector 823. Similarly, while the door 800 is in the closed state, the lock bolt receiver 824 is aligned with the lock bolt 808 such that the lock bolt 808 may be received in the aperture or opening of the lock bolt receiver 824. While in the closed state, the lock bolt receiver electrical connector 825 is aligned with or otherwise in close proximity to the lock bolt electrical connector 821 such that electrical energy may be transferred from the lock bolt receiver electrical connector 825 to the lock bolt electrical connector 821. The electrical energy that is transferred to the deadbolt electrical connector 823, the lock bolt electrical connector 821, or both may be transferred to electronics 816 via the electrical conductor 814 to be transformed into an energy state that may be received by or otherwise charge the rechargeable power supply 818 or the rechargeable sub-module 813.

The deadbolt receiver electrical connector 828 and/or the lock bolt receiver electrical connector 825 may be configured to transmit or transfer electrical energy in the form of alternating current (“AC”) power or direct current (“DC”) power. In such embodiments that utilize AC power, the AC power is received via the lock bolt electrical connector 821, the deadbolt electrical connector 823, or both, and transferred or conducted through the electrical conductor 814 to a transformer module (not shown) in the electronics 816 such that it may be transformed into DC power or some other power configuration that can be used in powering or recharging the rechargeable sub-module 813, the rechargeable power supply 818, or both. It should be understood that a variety of electrical components may be utilized in transferring and conditioning the electrical energy for storage in a rechargeable energy storage device, such as a rechargeable power supply 818 and/or rechargeable battery sub-module 813, which may provide supplemental back-up electrical energy storage. It should further be understood that the rechargeable energy storage device may take any form of energy storage, including chemical, kinetic (e.g., flywheel), or otherwise. In an embodiment, electronics may be configured to measure an energy storage level of the rechargeable power supply 818 or other energy storage element, and in response determining that the energy storage level is below a minimum threshold level, the electronics may be configured to generate an audible output signal, such as a beep or tone, or illumination signal (e.g., output light, such as a light emitting diode (LED)) to notify a user that the power level of the rechargeable power supply 818 is low.

The deadbolt receiver 827 may include one or more deadbolt receiver electrical connectors 828. The deadbolt receiver electrical connectors 828 may be a physical electrical connector, such that metal contacts (e.g., copper, aluminum, etc.), protrude from, are received by, or are otherwise in contact with the deadbolt receiver electrical connector 828 when the door 800 is in the closed state. In other embodiments, the deadbolt electrical connector 823 may be a physical electrical connector, such that metal contacts (e.g., copper, aluminum, etc.), either protrude from, are received by, or are otherwise in contact with the deadbolt receiver electrical connector 828 when the door 800 is in the closed state. Alternatively, deadbolt receiver electrical connectors 828 may be configured to transmit electrical power wirelessly through inductive wireless charging. In such embodiments, the deadbolt receiver electrical connector 828 may be configured with a coil of wire that an electrical current may pass through, thereby generating an electromagnetic field. In such embodiments, the deadbolt electrical connector 823 can include a coil of wire that is configured to generate an electrical current therein when the deadbolt electrical connector 823 is positioned within the electromagnetic field generated by the deadbolt receiver electrical connector 828, as understood by those in the art.

The lock bolt receiver 824 may include one or more lock bolt receiver electrical connectors 825. The lock bolt receiver electrical connectors 825 may be a physical electrical connector, such that metal contacts (e.g., copper, aluminum, etc.), protrude from, are received by, or are otherwise in contact with the lock bolt electrical connector 821 when the door 800 is in the closed state. In other embodiments, the lock bolt electrical connector 821 may be a physical electrical connector, such that metal contacts (e.g., copper, aluminum, etc.), protrude from, are received by, or are otherwise in contact with the lock bolt receiver electrical connector 825 when the door 800 is in the closed state. Alternatively, lock bolt receiver electrical connectors 825 may be configured to transmit electrical power wirelessly through inductive wireless charging. In such embodiments, the lock bolt receiver electrical connector 825 may be configured with a coil of wire that an electrical current may pass through, thereby generating an electromagnetic field. In such embodiments, the lock bolt electrical connector 821 can include a coil of wire that is configured to generate an electrical current therein when the lock bolt electrical connector 821 is positioned within the electromagnetic field generated by the lock bolt receiver electrical connector 825, as understood by those in the art. As the lock bolt receiver electrical connector 825 and the deadbolt receiver electrical connector 828 are positioned within the door frame 802, the lock bolt electrical connector 821 and the deadbolt electrical connector 823 may be configured in a manner that provides for efficient conductivity through direct or proximate contact with the lock bolt receiver electrical connector 825 and/or the deadbolt receiver electrical connector 828.

The rechargeable battery sub-module may be configured with an electrical connector on a top surface such that another sub-module may be electrically and mechanically connected thereto, such as shown in FIGS. 3A and 3B.

Referring now to FIG. 8B, which depicts an embodiment of a door frame 802 with a lock bolt receiver 824 and a deadbolt receiver 827 configured as illustrated in FIG. 8A with the addition of a lock bolt receiver electrical connector shutter 832 and a deadbolt receiver electrical connector shutter 834. The lock bolt receiver electrical connector shutter 832 is configured to enclose or otherwise cover the lock bolt receiver electrical connector 825 (not shown) when the door 800 is in the open state. In this manner, the lock bolt receiver electrical connector 825 is not exposed when the door 800 is open where people or other entities may be passing through the door frame 802. The lock bolt receiver electrical connector shutter 832 is constructed of substantially non-conductive materials such that a user may incidentally contact the lock bolt receiver electrical connector shutter 832 without receiving an electrical shock from the lock bolt receiver electrical connector 825. When the door 800 is positioned in the closed state, the lock bolt receiver electrical connector shutter 832 retracts into the door frame 802 or otherwise transitions to a position that allows for electrical energy to be transferred to the lock bolt electrical connector 821.

The deadbolt receiver electrical connector shutter 834 is configured to enclose or otherwise cover the deadbolt receiver electrical connector 828 (not shown) when the door 800 is in the open state. In this manner, the deadbolt receiver electrical connector 828 is not exposed when the door 800 is open where people may be passing through the door frame 802. The lock bolt receiver electrical connector shutter 832 is constructed of substantially non-conductive materials such that a user may incidentally contact the deadbolt receiver electrical connector shutter 834 without receiving an electrical shock from the deadbolt receiver electrical connector 828. When the door 800 is positioned in the closed state, the deadbolt receiver electrical connector shutter 834 retracts by way of mechanical or electromechanical element(s) into the door frame 802 or otherwise transitions to a position that allows for electrical energy to be transferred to the deadbolt electrical connector 823.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a sliding door lock, a sliding door, a window, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

In some embodiments, an integrated door lock may include at least one physical module supported by a door lock plate assembly and may include a keypad configured to enable the user to enter a keycode as at least one authentication data.

Examples may include a door lock including: an exterior door lock plate assembly configured to be secured to a door; electronics configured to perform at least one function to support the door lock; a rechargeable energy storage element in electrical communication with the electronics, and configured to store and supply electrical power to the electronics; an electrical conductor interface element in electrical communication with the rechargeable energy storage element; and an electrical conductor electrically connected between the rechargeable energy storage element and the electronics.

Examples of the door lock may include: a door lock bolt configured to secure the door to a door frame; and a lock bolt control element in mechanical communication with a lock bolt and configured to enable a user to open or secure the door to the door frame by retracting and extending the lock bolt by the user selectably applying and releasing a force to the lock bolt control element.

In some examples, the electrical conductor interface element is configured as a strike plate that is configured to be secured to a surface of the door that opposes a surface of the door frame that includes a corresponding electrical conductor interface element via which electrical power is transferred from the corresponding electrical connector interface element to the electrical conductor.

In some examples, the strike plate has a contact surface that is configured to contact a surface of the corresponding electrical conductor interface element.

In some examples, the strike plate defines an aperture through which the door lock bolt passes when extended from the door.

In some examples, the door lock bolt is a deadbolt.

In some examples, the door lock control element is a thumb turn configured to rotate to cause the deadbolt to extend or retract from the door.

In some examples, the electronics are configured to lock and unlock the door lock.

In some examples, the electronics are configured to measure an energy storage level of the energy storage element and in response determining that the energy storage level is below a minimum threshold level, the electronics are configured to generate an audible output signal.

In some examples, the electronics include a transformer configured to transform a first electrical power signal received by the electrical conductor interface element and communicate a second electrical signal to the energy storage element, and wherein the electrical conductor interface element is configured to receive electrical energy wirelessly.

In some examples, the door lock includes a retractable electrical conductor interface cover configured to cover the corresponding electrical conductor interface element when the door is positioned in an open state.

In some examples, the electronics further include an electrical power conditioner.

In some examples, a method of using a door lock includes: electrically connecting, by an electrical conductor interface element, a rechargeable energy storage element with an energy source; supplying electrical power, by the rechargeable energy storage element to electronics of the door lock; and executing, by the electronics, at least one function of the door lock.

In some examples, the method includes enabling a lock bolt control element, in mechanical communication with a lock bolt that is configured to enable a user to open or secure the door to the door frame by retracting and extending the lock bolt by the user selectably applying and releasing a force to the lock bolt control element.

In some examples, the electrical conductor interface element is configured as a strike plate that is configured to be secured to a surface of the door that opposes a surface of the door frame that includes a corresponding electrical conductor interface element via which electrical power is transferred from the corresponding electrical connector to the electrical connector.

In some examples, the strike plate has a contact surface that is configured to contact a surface of the corresponding electrical conductor interface element.

In some examples, the strike plate defines an aperture through which the door lock bolt passes when extended from the door.

In some examples, the door lock bolt is a deadbolt.

In some examples, the door lock control element is a thumb turn configured to rotate to cause the deadbolt to extend or retract from the door.

In some examples, the method includes enabling a deadbolt control element, in mechanical communication with a deadbolt that is configured to enable a user to open or secure the door to the door frame by retracting and extending the deadbolt by the user selectably applying and releasing a force to the deadbolt control element.

In some examples, the method includes measuring, by the electronics, an energy storage level of the energy storage element and in response determining that the energy storage level is below a minimum threshold level, generating an audible output signal.

What is claimed is:

1. An integrated door lock comprising:
a door lock plate assembly configured to be mounted to an exterior side of a door at a lock region;
a hands-free bump knob supported by the door lock plate and communicatively mechanically coupled to a bolt of the integrated door lock, configured to:
retract the bolt of the integrated door lock into a retracted state when the hands-free bump knob is pressed into an open state; and
extend the bolt of the integrated door lock into a non-retracted state when the hands-free bump knob is released from the open state into a closed state; and
the door lock plate assembly further configured to enable at least one physical module to be mechanically and communicatively attached thereto, the at least one physical module being communicatively coupled to an alarm system that monitors a premises and the at least one physical module being configured to transition the alarm system from an activated state to an inactivated state, and vice versa, when activated.

2. The integrated door lock of claim 1, further comprising a non-transitory memory configured to store information for at least one authorized user and at least one associated authentication data.

3. The integrated door lock of claim 2, further comprising an authentication module that includes at least one processor configured to receive a plurality of authentication data and validate at least one authentication data provided by the user by accessing the information stored in the non-transitory memory.

4. The integrated door lock of claim 3, wherein the at least one physical module further includes a keypad configured to enable the user to enter a keycode as the at least one authentication data.

5. The integrated door lock of claim 1, further comprising at least two physical sub-modules configured to enable the user to perform respective functions, wherein at least one of the physical sub-modules is configured to receive respective disparate authentication data from the user.

6. The integrated door lock of claim 3, further comprising wireless communications electronics configured to wirelessly communicate data to a data repository to update (i) a status of the integrated door lock with the user, (ii) timestamp a change of the status or interaction, and (iii) a type of the authentication data provided by the user.

7. The integrated door lock of claim 1, wherein the door lock plate assembly is further configured to enable a plurality of physical modules to be mechanically and communicatively attached thereto to add additional functionality to the integrated door lock.

8. The integrated door lock of claim 7, further comprising first electronics supported by the door lock plate assembly, and wherein the plurality of physical modules includes a second electronics configured to be electrically communicatively coupled to the first electronics.

9. The integrated door lock of claim 1, further comprising:
a second door lock plate assembly configured to be secured to an indoor side of the door, wherein the first and second door lock plate assemblies are further configured to be mechanically secured to one another via the door; and
wherein the second door lock plate assembly includes a second hands-free bump knob (i) supported by the second door lock plate assembly and (ii) communicatively mechanically coupled to the bolt of the integrated door lock, the second hands-free bump knob configured to retract the bolt of the integrated door lock to the retracted state when pressed into the open state and extend the bolt of the integrated door lock to the non-retracted state when released from the open state into the closed state.

10. A method of operating an integrated door lock, said method comprising:
receiving, by an authentication module of a door lock interface coupled to an exterior side of a door, authentication data from a user;
comparing, by the authentication module, the authentication data to a list of stored authentication data;
enabling a hands-free bump knob to transition a bolt to a retracted state if the authentication data matches the stored authentication data; and
in response to the hands-free bump knob being pressed, retracting the bolt.

11. The method according to claim 10, further comprising providing a memory configured to store information for at least one authorized user and the at least one authorized user's associated authentication information in a list of verified authentication data.

12. The method according to claim 11, further comprising enabling the hands-free bump knob to transition the bolt from a non-retracted state to the retracted state if at least two authentication data received matches at least two entries on the list of verified authentication data.

13. The method according to claim 11, further comprising receiving, by the authentication module the authentication data from a keypad of the authentication module.

14. The method according to claim 13, wherein receiving the authentication data involves receiving a keycode to enable the user to be authenticated.

15. The method according to claim 11, wherein receiving the authentication data from the user at the authentication module includes receiving a first authentication data from the user via a first sub-module and receiving a second authentication data from the user via a second sub-module.

16. The method according to claim 11, further comprising:
transmitting, via a wireless communications module, a status of the integrated door lock to a data repository, the status including a user ID, timestamp, and type of the authentication data provided by the user; and
updating the status of the integrated door lock in the data repository.

17. The method according to claim 11, further comprising:
setting an alarm communications module to an activated state;
transmitting a signal from the alarm communications module to an alarm system; and
setting the alarm system to transition to an ON state.

18. An integrated door lock comprising:
a door lock plate assembly configured to be mounted to an exterior side of a door at a lock region;
a hands-free bump knob supported by the door lock plate assembly, the hands-free bump knob communicatively mechanically coupled to a bolt of the integrated door lock, and configured to (i) retract the bolt of the integrated door lock into a retracted state when the hands-free bump knob is pressed into an open state and (ii) extend the bolt of the integrated door lock into a non-retracted state when the hands-free bump knob is released from the open state into a closed state; and
an authentication module supported by the door lock plate assembly and communicatively coupled and configured to (i) enable a user to be authenticated, and (ii) prevent the hands-free bump knob from transitioning the bolt from the non-retracted state to the retracted state until the user is authenticated.

19. The integrated door lock of claim 18, further comprising a non-transitory memory configured to store information for at least one authorized user and at least one associated authentication data.

20. The integrated door lock of claim 19, wherein the authentication module includes at least one processor configured to receive a plurality of authentication data and validate at least one authentication data provided by the user by accessing the information stored in the non-transitory memory.
